(19) United States
(12) Patent Application Publication
(10) Pub. No.: US 2016/0024942 A1
(43) Pub. Date: Jan. 28, 2016

(54) Abrasive Tipped Blades and Manufacture Methods

(71) Applicant: UNITED TECHNOLOGIES CORPORATION, Hartford, CT (US)

(72) Inventors: Paul R. Faughnan, JR., East Hampton, CT (US); Aaron T. Nardi, East Granby, CT (US); Michael A. Klecka, Vernon, CT (US)

(73) Assignee: UNITED TECHNOLOGIES CORPORATION, Hartford, CT (US)

(21) Appl. No.: 14/774,448

(22) PCT Filed: Dec. 3, 2013
(86) PCT No.: PCT/US2013/072707

§ 371 Date: Sep. 10, 2015

Related U.S. Application Data
(60) Provisional application No. 61/789,500, filed on Mar. 15, 2013.

(51) Int. Cl. F01D 5/28; C23C 24/04; F01D 5/14

(52) U.S. Cl. CPC F01D 5/288; F01D 5/147; C23C 24/04; F05D 2220/32; F05D 2240/307; F05D 2230/31; F05D 2300/174; F05D 2300/611; F05D 2300/16

(57) ABSTRACT

An article (104;140) has an airfoil (100). The airfoil has a leading edge (114), a trailing (116) edge, a pressure side (118), and a suction side (120) and the airfoil extends from a first end (110) to a tip (112). The article comprises an aluminum alloy or titanium alloy substrate (352) and a coating at the tip. The coating comprises a cold sprayed nickel or cobalt matrix (352) and an abrasive (354).

### CROSS-REFERENCE TO RELATED APPLICATION

Benefit is claimed of U.S. Patent Application Ser. No. 61/789,500, filed Mar. 15, 2013, the disclosure of which is incorporated by reference in its entirety herein as if set forth at length.

### BACKGROUND

The disclosure relates to gas turbine engines. More particularly, the disclosure relates to abrasive coatings for cold section blades.

FIG. 1 shows a gas turbine engine 20 having an engine case 22 surrounding a centerline or central longitudinal axis 500. An exemplary gas turbine engine is a turbofan engine having a fan section 24 including a fan 26 within a fan case 28. The exemplary engine includes an inlet 30 at an upstream end of the fan case receiving an inlet flow along an inlet flowpath 520. The fan 26 has one or more stages 32 of fan blades. Downstream of the fan blades, the flowpath 520 splits into an inboard portion 522 being a core flowpath and passing through a core of the engine and an outboard portion 524 being a bypass flowpath exiting an outlet 34 of the fan case.

The core flowpath 522 proceeds downstream to an engine outlet 36 through one or more compressor sections, a combustor, and one or more turbine sections. The exemplary engine has two axial compressor sections and two axial turbine sections, although other configurations are equally applicable. From upstream to downstream there is a low pressure compressor section (LPC) 40, a high pressure compressor section (HPC) 42, a combustor section 44, a high pressure turbine section (HPT) 46, and a low pressure turbine section (LPT) 48. Each of the LPC, HPC, HPT, and LPT comprises one or more stages of blades which may be interspersed with one or more stages of stator vanes.

In the exemplary engine, the blade stages of the LPC and LPT are part of a low pressure spool mounted for rotation about the axis 500. The exemplary low pressure spool includes a shaft (low pressure shaft) 50 which couples the blade stages of the LPT to those of the LPC and allows the LPT to drive rotation of the LPC. In the exemplary engine, the shaft 50 also drives the fan. In the exemplary implementation, the fan is driven via a transmission (not shown, e.g., a fan gear drive system such as an epicyclic transmission) to allow the fan to rotate at a lower speed than the low pressure shaft.

The exemplary engine further includes a high pressure shaft 52 mounted for rotation about the axis 500 and coupling the blade stages of the HPT to those of the HPC to allow the HPT to drive rotation of the HPC. In the combustor 44, fuel is introduced to compressed air from the HPC and combusted to produce a high pressure gas which, in turn, is expanded in the turbine sections to extract energy and drive rotation of the respective turbine sections and their associated compressor sections (to provide the compressed air to the combustor) and fan.

Each of the fan section stage(s), compressor section stages, and turbine section stages may comprise a circumferential array of blades. The blades are typically secured to or unitarily formed with an associated annular structure often identified as a hub and/or disk. Cold section components (fan and compressor) are typically formed of titanium and/or aluminum alloys and composites. Hot section components (combustor and turbine) are typically formed of nickel-based superalloys.

An exemplary disk has a generally annular web extending radially outward from an inboard annular protuberance known as a “bore” to an outboard peripheral portion (e.g., bearing an array of blade attachment slots). The bores encircle central apertures of the disks through which the portion engine shafts may pass. The slots are configured to receive complementary attachment root portions of a blade.

FIG. 2 shows blade airfoils 100 unitarily formed with a peripheral portion 102 (e.g., as a single piece with continuous microstructure machined from a single piece of raw material) of an integrally bladed rotor (IBR) or “blisk” 104. The exemplary portion 102 is a rim. Similar structures may be non-unitarily integrally formed (e.g., via welding so as to render the blades only destructively removable). The airfoils have a span from a first end to a second end. The exemplary first end 110 is an inboard end and the exemplary second end 112 is an outboard end or tip. The airfoil extends streamwise from a leading edge 114 to a trailing edge 116 and has a pressure side 118 and a suction side 120.

FIG. 3 shows a blade 140 wherein the airfoil inboard end 110 is adjacent a platform 142. An attachment root 144 (e.g., firtree or button) is opposite the airfoil for mounting in a complementary slot of a disk (not shown)

The exemplary tips are unshrouded (free), but alternatives may be shrouded. Often, the blade tips have abrasive coatings.

For Ti-alloy and Al-alloy blades, plating of a nickel matrix for a tip abrasive coating is a known technique. U.S. Pat. No. 5,074,970 of Routsis et al. discloses a multi-stage plating process for entrapping abrasive particles in a nickel matrix on the tips of Ti-alloy blades. Such processes can be expensive and/or time-consuming. For Ni-superalloy or Co-superalloy blades, spray techniques have been used. U.S. Patent Application Publication 2003/0126800 discloses cold spray of an MCrAly matrix and an abrasive onto a Ni- or Co-superalloy blade tip.

Various other techniques are disclosed in U.S. Pat. No. 5,389,228 of Long et al., U.S. Pat. No. 5,476,363 of Freling et al., U.S. Pat. No. 5,551,840 of Benoit et al., and U.S. Pat. No. 5,603,603 of Benoit et al., and U.S. Patent Application Publications 2013/0004328 of Seth et al., 2007/0248750 of Allen, 2008/0286108 of Liu et al, and 2010/0040775 of Arndt et al.

### SUMMARY

One aspect of the disclosure involves an article comprising an airfoil. The airfoil has a leading edge, a trailing edge, a pressure side, and a suction side and the airfoil extends from a first end to a tip. The article comprises an aluminum alloy or titanium alloy substrate and a coating at the tip. The coating comprises a cold sprayed nickel or cobalt matrix and an abrasive.

In one or more embodiments of any of the foregoing embodiments, the article is a blade wherein the tip is an outboard tip.

In one or more embodiments of any of the foregoing embodiments, the article further comprises an attachment root.

In one or more embodiments of any of the foregoing embodiments, the article is one of a plurality of blades of an integrally bladed rotor, the first end being along a rotor rim.

In one or more embodiments of any of the foregoing embodiments, the substrate comprises Ti6Al4V or Ti-6Al-2Sn-4Zr-2Mo or Ti-6Al-2Sn-4Zr-6Mo.

In one or more embodiments of any of the foregoing embodiments, the matrix consists essentially of nickel.

In one or more embodiments of any of the foregoing embodiments, the abrasive comprises cubic boron nitride.

In one or more embodiments of any of the foregoing embodiments, the coating has a characteristic thickness of at least 0.003 inches (0.008 mm).

In one or more embodiments of any of the foregoing embodiments, the coating is localized to the tip.

In one or more embodiments of any of the foregoing embodiments, the coating is directly atop the substrate.

Another aspect involves a method for manufacturing the article. The method comprises cold co-spraying of the matrix and the abrasive.

In one or more embodiments of any of the foregoing embodiments, the cold co-spraying comprises spraying a powder mixture.

In one or more embodiments of any of the foregoing embodiments, the cold co-spraying comprises spraying the matrix from one nozzle and the abrasive from another.

In one or more embodiments of any of the foregoing embodiments, the cold co-spraying comprises spraying in the absence of melting.

Another aspect of the disclosure involves a method for manufacturing a gas turbine engine airfoil. The method comprises cold co-spraying of a metallic matrix and an abrasive to an aluminum or titanium alloy tip of the airfoil.

In one or more embodiments of any of the foregoing embodiments: the airfoil comprises a titanium alloy; the matrix comprises essentially pure nickel; and the cold co-spraying comprises spraying a powder mixture.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a longitudinal sectional view of a gas turbine engine.

FIG. 2 is a partial view of an integrally bladed rotor (IBR) of the engine.

FIG. 3 is a schematic view of a coating apparatus applying coating to a blade.

FIG. 4 is a simplified sectional view of as-applied coating.

FIG. 5 is a simplified sectional view of as-applied coating post-exposure.

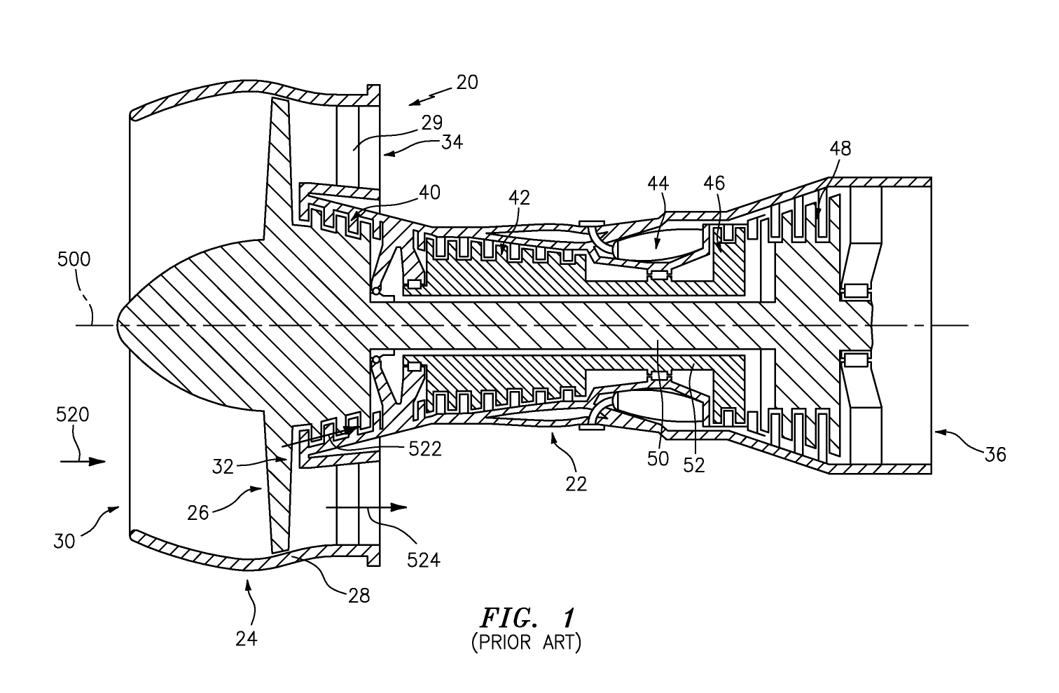

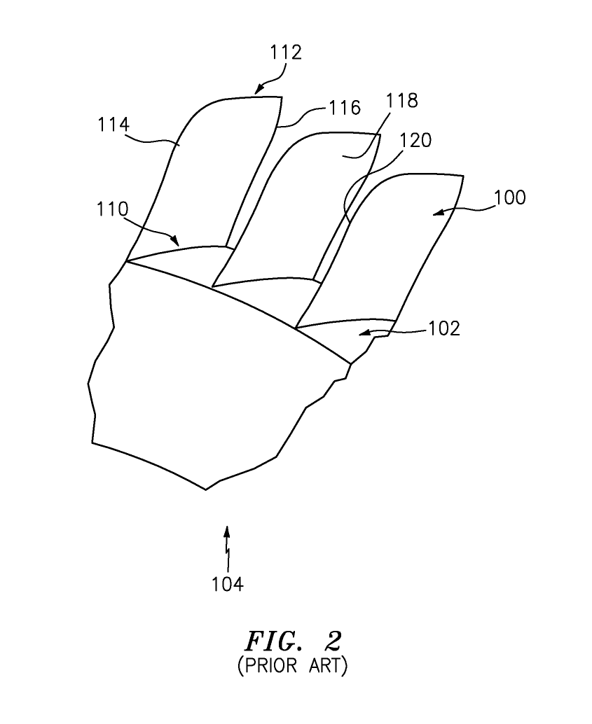

Like reference numbers and designations in the various drawings indicate like elements.

### DETAILED DESCRIPTION

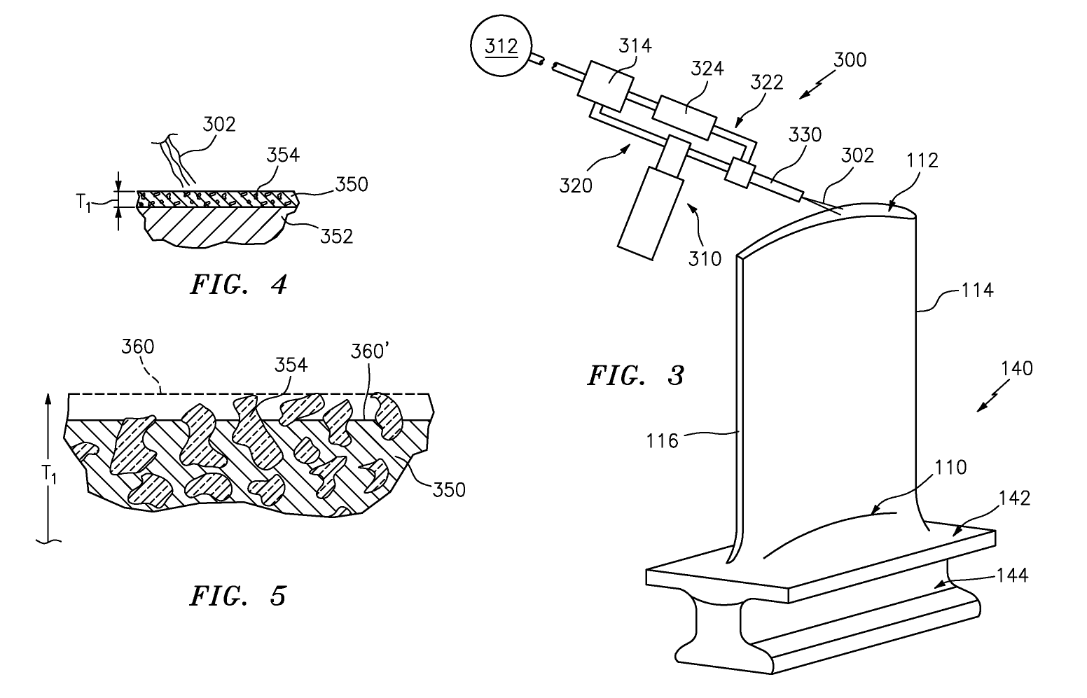

FIG. 3 shows a cold spray apparatus 300 discharging a mixture spray 302 of matrix and abrasive (and carrier gas) to an airfoil end (e.g., a tip of a Ti-alloy airfoil blade (e.g., Ti6Al4V or Ti-6Al-2Sn-4Zr-2Mo or Ti-6Al-2Sn-4Zr-6Mo)). Although an individual blade is shown, alternative airfoil ends may include those on an IBR and stator airfoil free inboard ends.

The exemplary matrix and abrasive are codeposited in a cold gas dynamic spray (“cold spray”) process. An exemplary cold spray process is disclosed in U.S. Pat. No. 5,302,414 of Alkhimov et al. In one exemplary process a first stream or flow of carrier gas is used to convey powder from a powder reservoir to a nozzle. A second stream of the carrier gas is heated and then passed to the nozzle to mix with the first stream and to be accelerated in and discharged from the nozzle toward the workpiece. The heat input is insufficient to melt the powder.

This technique provides sufficient energy to accelerate particles to high enough velocities such that, upon impact, the particles plastically deform and bond to the surface of the component on which they are being deposited so as to build a relatively dense coating or structural deposit. Cold spray does not metallurgically transform the particles from their solid state.

The exemplary matrix may be an essentially pure nickel or cobalt. More narrowly, it may be of the “commercially pure” grade. More broadly, the nickel will typically have no more than 1% by weight (more narrowly no more than 0.5%) of any individual other element and no more than 3% by weight (more narrowly 1%) aggregate of all other elements. This being said, alloying elements that do not substantially increase melting temperature or reduce softening in APS (e.g., alloying elements that do not adversely affect the substrate or do not cause poor bonding) may be used. The exemplary abrasive is cubic boron nitride (CBN). Alternative abrasives include, but are not limited to, alumina, silicon carbide, or mixtures of abrasives. The matrix/abrasive mixture may be stored as a powder in a reservoir of a powder feeder 310. A carrier gas source 312 provides carrier gas to a gas control module 314 that splits the gas into two flows. A first flow passes along a first branch 320 to the feeder where it entrains the matrix and abrasive particulate. A second flow passes through a second branch 322 having an electric heater 324. The two flows merge at a supersonic nozzle 330 where they accelerate and are discharged as the spray. Alternative apparatus may have respective nozzles for the matrix and abrasive, with flows mixing after discharge. FIG. 4 shows matrix metal 350 atop the Ti-alloy substrate 352. it also shows embedded abrasive 354

Exemplary deposition is uniform and to an initial thickness T₁ (e.g., 0.003-0.005 inches (0.08-0.13 mm), more broadly, 0.05-0.25 mm). Other examples could include varying the matrix-to-abrasive ratio during deposition (e.g., starting relatively matrix-rich).

After deposition, an exposure process may be used to locally remove matrix near the initial coating surface 360 to the final coating surface 360′ (FIG. 5) so as to increase abrasive exposure and thereby increase the abrasive effect of the tip. Exemplary exposure involves an ablative process, such as laser machining, a grit blast type process where matrix is removed with a sprayed abrasive, or a chemical etching process that attacks the binder matrix.

In a repair situation, a standard repair process chain would apply (e.g., including stripping existing abrasive and binder and then repeating the cold spray process).

In cold spray deposition of a mixture such as a first particulate for forming matrix and second particulate to be embedded therein, only the matrix powder may be subject to the deformations necessary for cold spray bonding. The second particulate may have much higher melting/softening temperatures and may remain relatively rigid/non-deformed during the process.

In the present example, both particulates may remain below melting temperature.

In one or more embodiments, the process may have one or more of several advantages relative to plating processes. Masking may be reduced or eliminated saving cycle time and labor costs. Similarly, by eliminating plating, cycle time may be reduced. Handling and processing of plating chemicals may be reduced, resulting in environmental advantages. Part staining from plating media may be reduced. Active process control may provide greater consistency and reduce re-work.

The use of “first”, “second”, and the like in the following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

Where a measure is given in English units followed by a parenthetical containing SI or other units, the parenthetical's units are a conversion and should not imply a degree of precision not found in the English units.

One or more embodiments have been described. Nevertheless, it will be understood that various modifications may be made. For example, when applied to an existing basic blade configuration, details of such configuration or its associated engine may influence details of particular implementations. Accordingly, other embodiments are within the scope of the following claims.

1. An article (104;140) comprising:
an airfoil (100) having a leading edge (114), a trailing edge (116), a pressure side (118), and a suction side (120) and extending from an a first end (110) to a tip (112),
wherein:
the article comprises an aluminum alloy or titanium alloy substrate (352) and a coating at the tip; and
the coating comprises a cold sprayed nickel or cobalt matrix (350) and an abrasive (354).

2. The article of claim 1 being a blade wherein the tip is an outboard tip.

3. The article of claim 1 further comprising:
an attachment root (144).

4. The article of claim 1 wherein:
the article is one of a plurality of blades (100) of an integrally bladed rotor (104), the first end being along a rotor rim (102).

5. The article of claim 1 wherein:
the substrate comprises Ti6Al4V or Ti-6Al-2Sn-4Zr-2Mo or Ti-6Al-2Sn-4Zr-6Mo.

6. The article of claim 1 wherein:
the matrix consists essentially of nickel.

7. The article of claim 1 wherein:
the abrasive comprises cubic boron nitride.

8. The article of claim 1 wherein:
the coating has a characteristic thickness of at least 0.003 inches (0.008 mm).

9. The article of claim 1 wherein:
the coating is localized to the tip.

10. The blade of claim 1 wherein:
the coating is directly atop the substrate.

11. A method for manufacturing the article of claim 1, the method comprising:
cold co-spraying of the matrix and the abrasive.

12. The method of claim 11 wherein:
the cold co-spraying comprises spraying a powder mixture.

13. The method of claim 11 wherein:
the cold co-spraying comprises spraying the matrix from one nozzle and the abrasive from another.

14. The method of claim 11 wherein:
the cold co-spraying comprises spraying in the absence of melting.

15. A method for manufacturing a gas turbine engine airfoil (100), the method comprising:
cold co-spraying of a metallic matrix (350) and an abrasive (354) to an aluminum or titanium alloy tip (112) of the airfoil.

16. The method of claim 15 wherein:
the airfoil comprises a titanium alloy;
the matrix comprises essentially pure nickel; and
the cold co-spraying comprises spraying a powder mixture.

17. The method of claim 14 wherein:
a matrix has no more than 1% by weight of any individual element other than nickel and no more than 3% by weight aggregate of all elements other than nickel.

18. The method of claim 17 wherein:
the matrix has no more than 0.5% by weight of any individual element other than nickel and no more than 1% by weight aggregate of all elements other than nickel.

19. The method of claim 1 wherein:
a matrix has no more than 1% by weight of any individual element other than nickel and no more than 3% by weight aggregate of all elements other than nickel.

20. The method of claim 19 wherein:
the matrix has no more than 0.5% by weight of any individual element other than nickel and no more than 1% by weight aggregate of all elements other than nickel.
